(19) United States
(12) Patent Application Publication
(10) Pub. No.: US 2007/0183165 A1
(43) Pub. Date: Aug. 9, 2007

(54) Direct Lighting Vehicular Lamp

(75) Inventors: Anita Sure, Bangalore (IN); Vishnu S. Vardhanan, Vellore (IN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/307,441

(22) Filed: Feb. 7, 2006

(51) Int. Cl. F21V 1/00

(52) U.S. Cl. 362/509

(57) ABSTRACT

According to an aspect of the present invention, lenses used for directing the light beams from lighting elements in a direct lighting vehicular lamp are constructed on an inner lens assembly that is separate from the lamp enclosure. Such a physical separation of the lens assembly and the lamp enclosure may permit complex profiles incorporating stylistic and aesthetic features to be chosen for the lamp enclosure, while maintaining ease of manufacturability.

### BACKGROUND OF THE INVENTION

1. Field of the Invention

The present invention generally relates to vehicular lamp design, and specifically to a direct lighting vehicular lamp potentially permitting complex styling and ease of manufacturability.

2. Related Art

Lamps (“direct lighting lamps”) frequently use lighting elements which face a zone sought to be lighted, and thus directly illuminate the zone. For example, light-emitting diodes (LED) may be used in vehicular lamps such as brake and tail lamps to directly illuminate a zone of interest lying in front of (facing) the LEDs. The direct lighting lamps differ from the indirect lighting lamps in that the indirect lighting lamps use reflecting surfaces (e.g., aluminum coated cones) to direct the beam to the zone in front (and thus do not face the zone sought to be lighted).

Direct lighting lamps generally contain directing elements (such as spherical/cylindrical convex lenses) to direct the light output (from the light sources such as LEDs) to obtain desired illumination intensities in desired zones, while also typically giving a more uniform appearance.

In a prior approach, lens used for directing the light output in a direct lighting vehicular lamp are constructed on an inner surface of the lamp enclosure. Such an approach may, however, constrain the designer to using less complex shapes (profiles) for the lamp enclosure, so that manufacturing of the lamp enclosure is maintained simple/feasible. Consequently, such an approach may not facilitate provision of desired stylistic/aesthetic features in the lamp enclosure.

Thus, what is required is direct lighting vehicular lamp that provides considerable freedom to the designer and user in choosing the stylistic aspects (such as size and profile of the lamp enclosure) of the overall design. It may be further desirable that such a feature be provided while ensuring that the processes involved in manufacturing the lamp enclosure and various components/sub-assemblies of the lamp are maintained simple.

Accordingly, the present invention provides a design for a direct lighting vehicular lamp that permits incorporating complex styling for the lamp, and ease of manufacturability.

### BRIEF DESCRIPTION OF THE DRAWINGS

The present invention will be described with reference to the accompanying drawings, which are described below briefly.

FIGS. 1A, 1B and 1C are diagrams showing a 3D (three-dimensional) sectional view, a 3D view and a sectional view respectively from different angles of an example embodiment of a direct lighting vehicular lamp that uses an LED array as the lighting elements, according to an aspect of the present invention.

FIGS. 2A, 2B and 2C are diagrams showing sectional views from different angles of the example embodiment shown in FIGS. 1A-1C. FIG. 2D is a diagram showing the top view of the example embodiment shown in FIGS. 1A-1C.

FIG. 3 is a diagram showing an exploded view of the example embodiment shown in FIGS. 1A-1C/2A-2D, with the various components/sub-assemblies being shown separately.

FIG. 4 is a diagram showing a 3D view of the inner lens assembly used in the example embodiment of FIGS. 1A-1C/2A-2D.

FIG. 5 is a diagram illustrating the need for using directing elements in a direct lighting vehicular lamp.

In the drawings, like reference numbers generally indicate identical, functionally similar, and/or structurally similar elements. The drawing in which an element first appears is indicated by the leftmost digit (s) in the corresponding reference number.

### DETAILED DESCRIPTION

1. Overview

A direct lighting vehicular lamp provided according to an aspect of the present invention contains a lens assembly and a lamp enclosure provided as physically separate components. The lens assembly may contain multiple lenses directing the light output from one or more lighting elements, and the lamp enclosure covers the inner components (lens assembly and LEDs).

Since the lamp enclosure is provided as a physically separate component from the lens assembly, the lamp enclosure can be designed to meet any desired specification, for example, to meet aesthetic/stylistic requirements.

According to another aspect of the present invention, the lenses constructed on the inner lens assembly are cylindrical lenses. This allows greater tolerances to be provided to the mounting positions of the lighting elements on a corresponding mounting sub-assembly such as a printed circuit board (PCB).

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

2. Vehicular Lamp

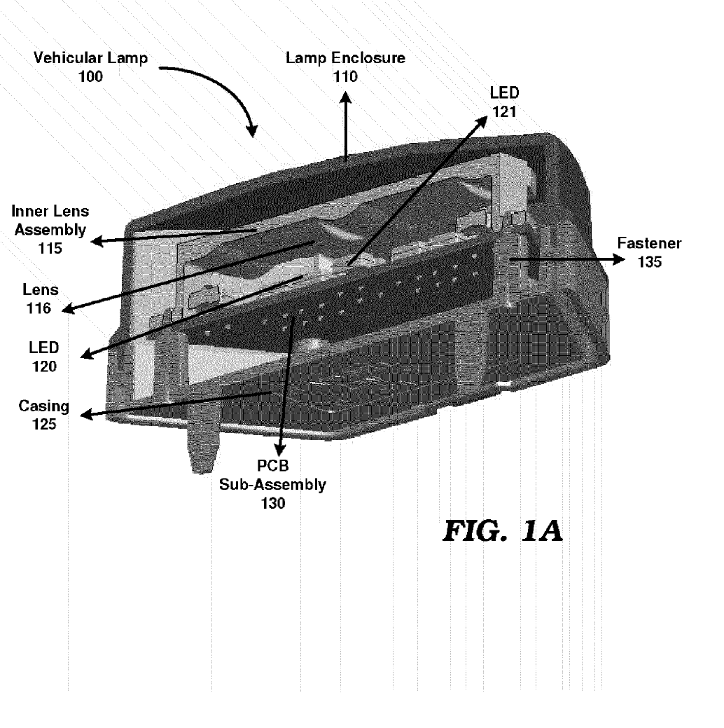

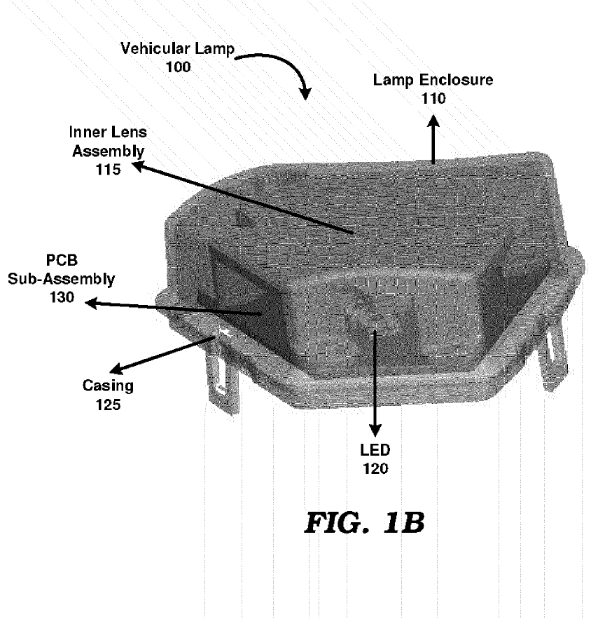

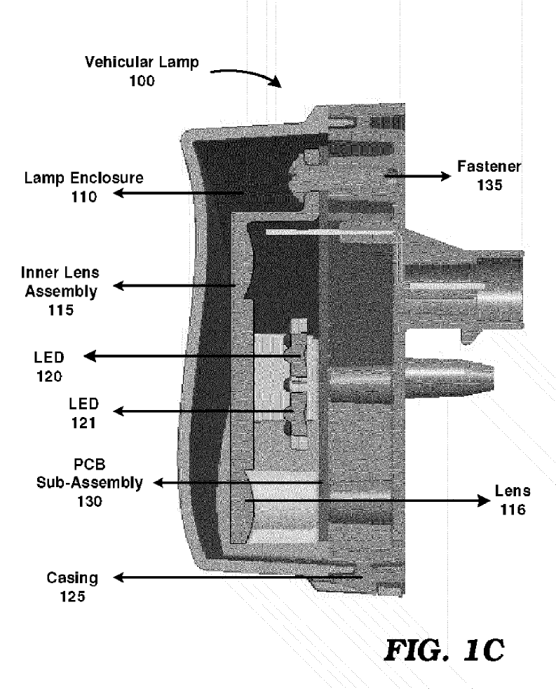

FIGS. 1A, 1B and 1C are diagrams showing a 3D (three-dimensional) sectional view, a 3D view and a sectional view respectively from different angles of an example embodiment of a direct lighting vehicular lamp that uses an LED array as the lighting elements, according to an aspect of the present invention. Each diagram in FIGS. 1A-1C is shown containing lamp enclosure 110, inner lens assembly 115, printed circuit board (PCB) sub-assembly 130 and casing 125. Each Figure contains additional components, as suited in the corresponding view. While the following sections are described with respect to a direct lighting vehicular lamp that uses multiple LEDs as lighting elements, other lighting elements can also be used. Each component is described in further detail below.

Inner lens assembly 115 contains the lenses used for directing the light output from LEDs (example LEDs 120 and 121, shown in FIG. 1C) mounted on PCB sub-assembly 130, and may be constructed using any clear and transparent polymer or glass. In an embodiment, inner lens assembly 115 is constructed using poly-carbonate material, and contains cylindrical lenses constructed on a surface facing the LEDs (example LEDs 120 and 121) on PCB sub-assembly 130. Inner lens assembly 115 is mounted on PCB sub-assembly using fasteners (fastener 135 is shown in FIG. 1A).

PCB sub-assembly 130 may be constructed using any PCB material and has LEDs mounted on it in a desired arrangement to obtain a desired illumination. LEDs may be of any type such as axial lead LEDs, surface-mount package, etc. PCB sub-assembly 130 is mounted on casing 125 using fasteners (fastener 135 is shown in FIG. 1A).

Casing 125 is a structure on which inner lens assembly 115, PCB sub-assembly 130 and lamp enclosure 110 are fitted. In an embodiment, casing 125 is constructed using fiber reinforced glass and has a groove to accommodate lamp enclosure 110.

Lamp enclosure 110 encloses inner lens 115 and PCB-subassembly 130, and may be designed to have a desired shape/profile. Lamp enclosure 110 may be constructed using any clear and transparent polymer or glass, and in an embodiment is constructed using polycarbonate material.

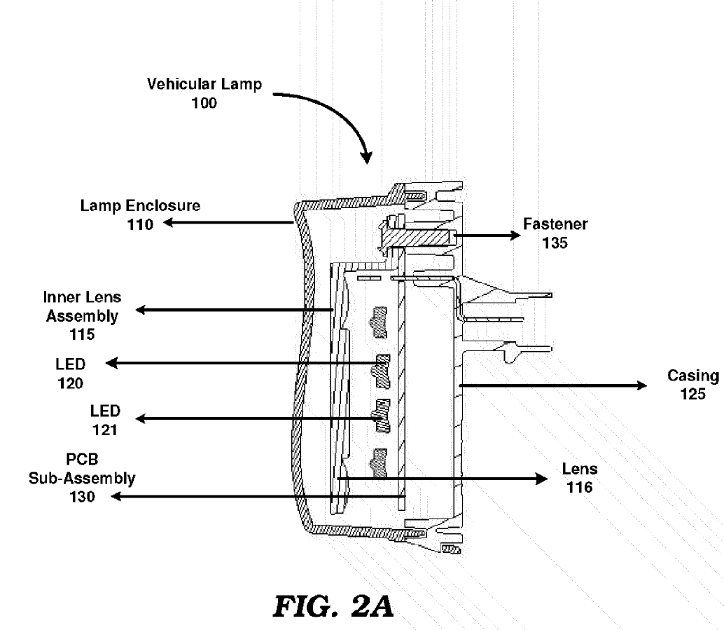

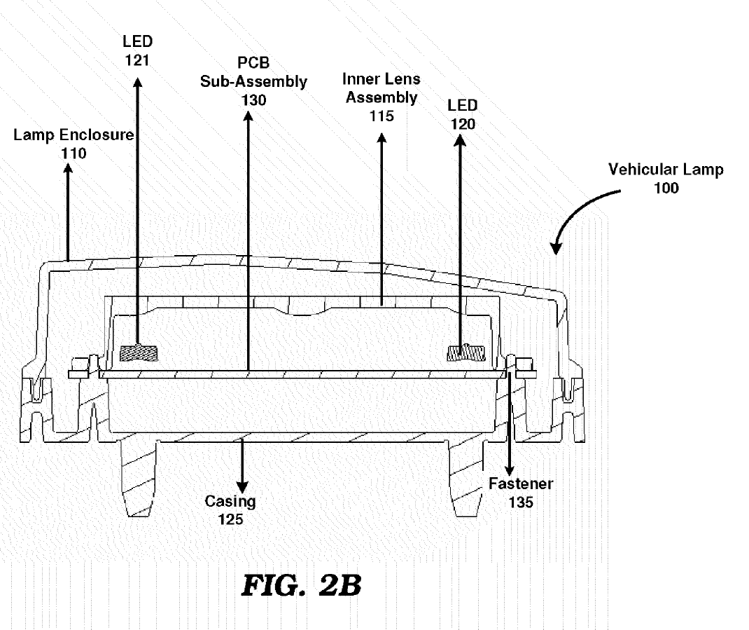

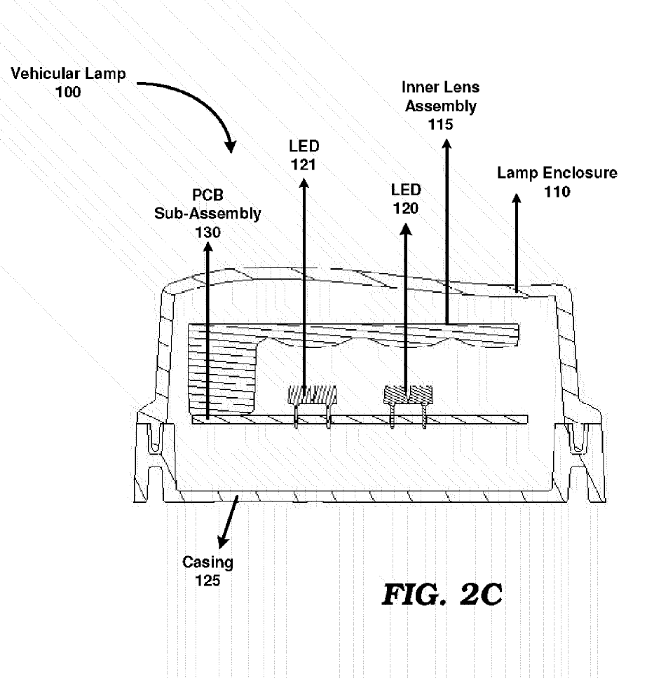

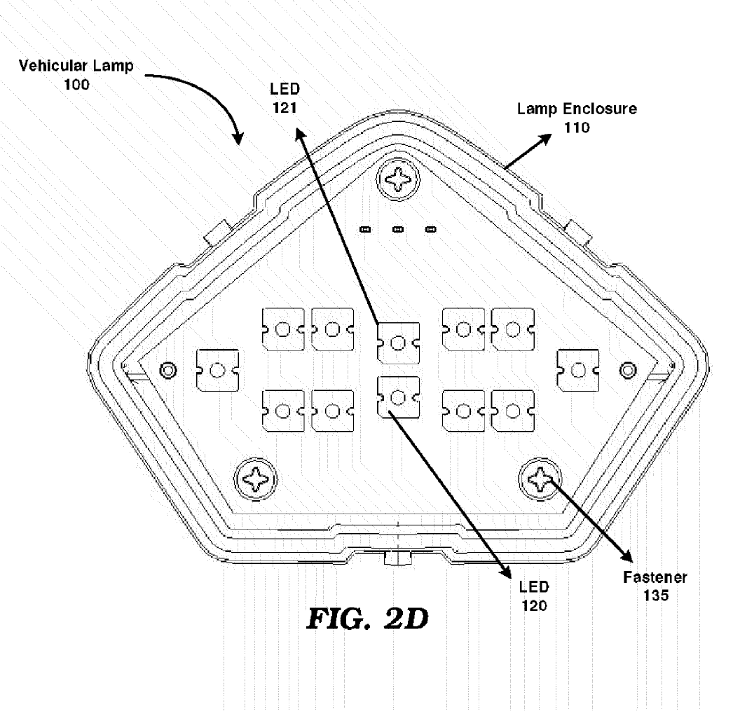

FIGS. 2A, 2B and 2C are diagrams showing sectional views from different angles of vehicular lamp 100, and FIG. 2D is a diagram showing the top view of vehicular lamp 100. The various components/assemblies shown in each of FIGS. 2A-2D correspond to similarly numbered components/assemblies in the drawings of FIGS. 1A-1C.

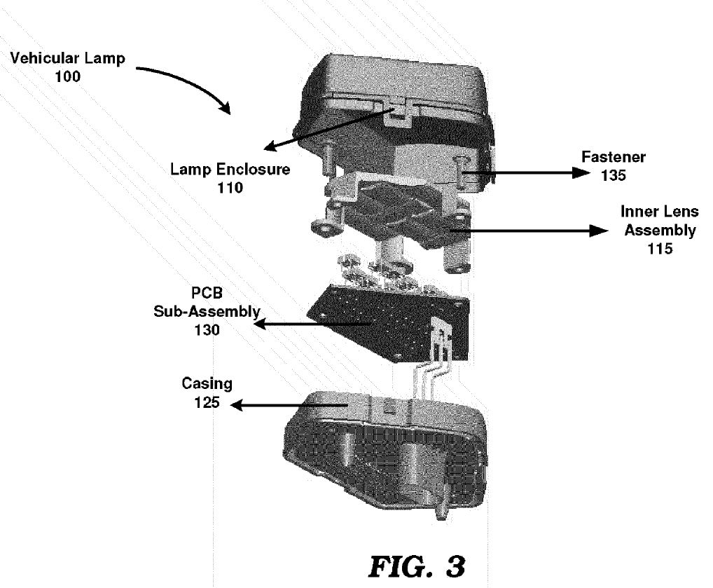

Since, directing elements used to obtain a desired illumination are constructed on an assembly (inner lens assembly 115 in FIGS 1A-1C and 2A-2D) physically separate from the lamp enclosure 110, the designer/user has a greater degree of freedom in choosing desired stylistic/aesthetic features for lamp enclosure 110. This may be better appreciated from FIG. 3 which is a diagram showing an exploded view of vehicular lamp 100, with lamp enclosure 110, PCB sub-assembly 130, inner lens assembly 115 and casing 125 being shown separately.

It is generally desirable to construct lenses on inner lens assembly 115 such that greater error tolerance is provided to the positions at which LEDs in PCB sub-assembly 130 need to be mounted. In the example embodiment (vehicular lamp 100) shown in FIGS. 1A-1C and 2A-2D, this is achieved using cylindrical lenses. The description is continued with an illustration of the inner lens assembly 115 in an example embodiment.

3. Inner Lens Assembly

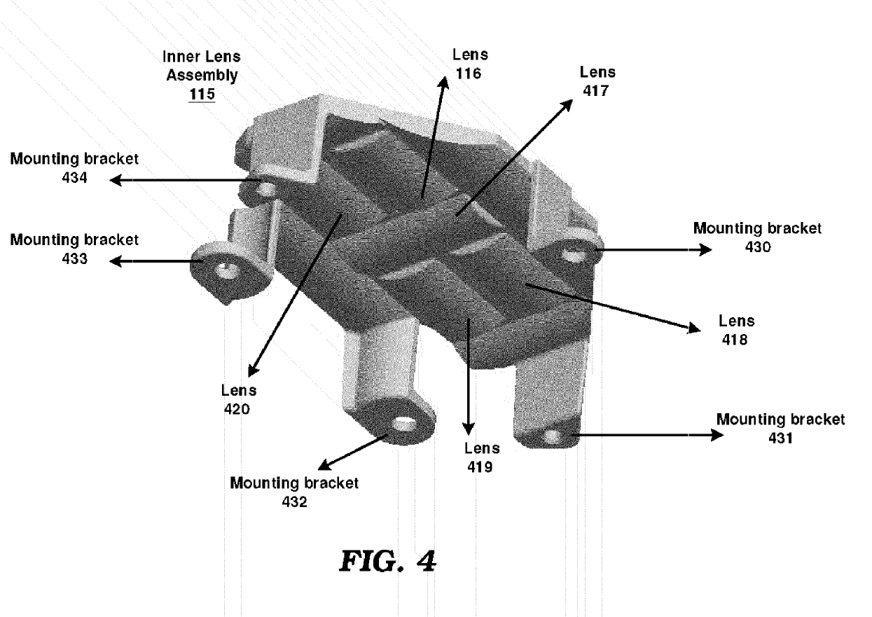

FIG. 4 is a diagram showing a 3D view of inner lens assembly 115 illustrating the construction of directing lenses on an inner surface (i.e., facing the LED array) of the inner lens assembly. Lenses 116, 417-420 are cylindrical lenses constructed on an inner surface. As may be seen from FIGS. 1A-1C and 2A-2D, each of lenses 116/417-420 serves to direct the light output from two or more corresponding LEDs. Since each lens is cylindrical, corresponding LEDs may be positioned on PCB sub-assembly 130 with greater tolerance along the direction corresponding to the axis of the lens.

Mounting brackets 430-434 are used for fastening inner lens assembly 115 to casing 125 (of FIGS. 1A-1C and 2A-2D). While the above description is provided with respect to cylindrical lenses, other kinds of lenses may be used (for example, spherical lens), for example, where tolerance for LED positions is not a requirement.

The operation of the lamp may be better appreciated with a brief description of the functioning of the optics and the need for directing elements in an LED lamp. This is provided below.

4. Directing Elements in an LED Lamp

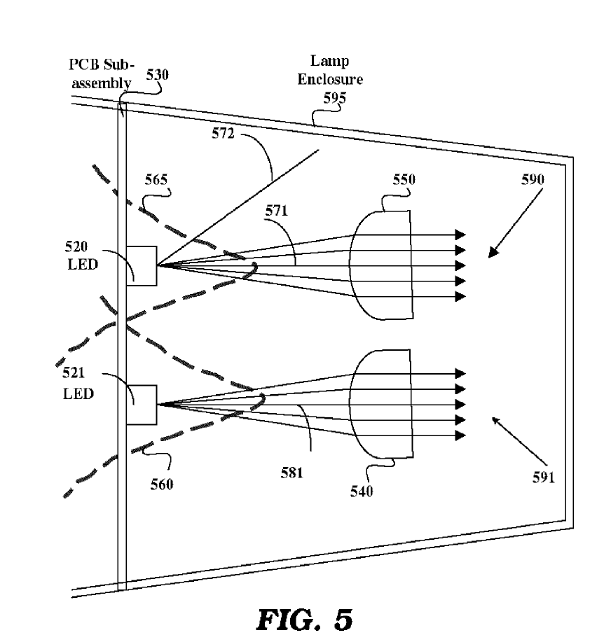

FIG. 5 is a diagram illustrating the operation and use of directing elements in an LED lamp in one embodiment. The diagram is shown containing LEDs 520 and 521, printed circuit board (PCB) sub-assembly 530, lamp enclosure 595 and directing lenses 540 and 550. Each component is described below in greater detail.

LEDs 520 and 521are representative LEDs (and may correspond to LEDs 120-121 of FIG. 1A) comprising an LED array used for providing the light source in lamp 100 (of FIGS. 1A-1C, 2A-2D). In FIG. 5, the light produced by LEDs 520 and 521 has been approximated as originating from a point source. LEDs 520 and 521 are mounted on PCB sub-assembly 530 (which corresponds to PCB sub-assembly 130 of FIGS. 1A-1C/2A-2D), and may be mounted on a suitable assembly/casing (not shown) as described in sections above.

Directing lenses 540 and 550 are positioned in the path of the light produced by LEDs 521 and 520, and may be spherical or cylindrical lenses. Further, directing lenses 520 and 521 may be separate elements or constructed on a single element (usually of polymer or glass, and corresponding to inner lens assembly 115 of FIGS. 1A-1C/2A-2D).

Curves 565 and 560 represent the intensity distribution of the light output from LEDs 520 and 521 respectively as a function of the angle from the optical axis (path 571 for LED 520 and path 581for LED 521). The light intensity is maximum along the optical axis and decreases as the angle from the optical axis increases. Thus, for example, the intensity of light output from LED 520 along path 572 will be lesser than a corresponding intensity along path 571.

The effect of directing lenses 540 and 550 is to direct the light outputs from LEDs 521 and 520 respectively, and produce light outputs (591 and 590) so as to meet required specifications/standards. Without the effect of directing lenses 540 and 550, the light outputs from LEDs 521 and 520 may not provide a desired (for example, as required by automotive standards) illumination meeting a corresponding photometric specification.

Thus, an aspect of the present invention provides directing lenses (similar to directing lenses 540 and 550) as a separate unit, permitting the lamp enclosure to be designed using more complex profiles and incorporating desired aesthetic features.

5. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A direct lighting vehicular lamp to light a zone of interest, said lamp comprising:
a plurality of lighting elements facing said zone of interest and generating a light output;
a lens assembly containing a plurality of lenses directing said light output to said zone of interest;
a lamp enclosure enclosing said plurality of LEDs and said lens assembly,
wherein said lens assembly is positioned between said plurality of LEDs and said lamp enclosure; and
said lens assembly and said lamp enclosure are implemented as physically separate units.

2. The direct lighting vehicular lamp of claim 1, wherein each of said plurality of lenses comprises a cylindrical lens.

3. The direct lighting vehicular lamp of claim 1, further comprising a casing on which said plurality of LEDs, said lens assembly and said lamp enclosure are mounted.

4. The direct lighting vehicular lamp of claim 3, further comprising a printed circuit board (PCB) on which said plurality of LEDs are mounted, and each of said plurality of LEDs comprises a surface-mount package for mounting on said PCB.

5. The direct lighting vehicular lamp of claim 4, wherein said plurality of lenses are constructed on a surface of said lens assembly that faces said plurality of LEDs.

6. The direct lighting vehicular lamp of claim 1, wherein said lamp enclosure is permitted to have a complex shape.
